(19) United States
(12) Patent Application Publication
(10) Pub. No.: US 2021/0131403 A1
(43) Pub. Date: May 6, 2021

(54) CALIBRATING A WIND SENSOR OF A WIND TURBINE

(71) Applicant: TORBEN NIELSEN, SPORUP (DK)

(72) Inventor: TORBEN NIELSEN, SPORUP (DK)

(21) Appl. No.: 16/487,237

(22) PCT Filed: Nov. 24, 2017
(86) PCT No.: PCT/EP2017/080408

§ 371 Date: Aug. 20, 2019

(30) Foreign Application Priority Data
Feb. 23, 2017 (DE) 10 2017 202 967.6

(51) Int. Cl. F03D 17/00

(52) U.S. Cl. CPC F03D 17/00; F05B 2270/802; F05B 2270/32

(57) ABSTRACT

A method is provided for determining calibration information for at least one wind speed sensor of a wind turbine, wherein measured wind speed information is provided by the at least one wind speed sensor, wherein free wind speed information is estimated based on wind turbine individual operational information, wherein the calibration information is determined based on the measured wind speed information and the estimated free wind speed information. Further, a wind turbine and a device as well as a computer program product and a computer readable medium are suggested for performing the method.

### CROSS-REFERENCE TO RELATED APPLICATIONS

This application claims priority to PCT Application No. PCT/EP2017/080408, having a filing date of Nov. 24, 2017, which is based on German Application No. 10 2017 202 967.6, having a filing date of Feb. 23, 2017, the entire contents both of which are hereby incorporated by reference.

### FIELD OF TECHNOLOGY

The following relates to a method, a wind turbine and to a device for determining calibration information of a wind turbine. In addition, an according computer program product and a computer readable medium are suggested.

### BACKGROUND

A proper and effective control and/or operation of a wind turbine or wind farm/park is based on accurate wind speed information representing a result of a measurement or determination of wind speed, in particular of free wind speed in front of the wind turbine.

As an example, the wind speed information may be used for initiating a turbine start up, for stopping in a high wind situation (following security regulations) and for further control features like, e.g., ice detection. Furthermore, the wind speed information may be used by customers like wind farm operators to confirm performance of a wind turbine usually defined by a wind turbine specific power curve.

According to one possible scenario a wind turbine may be equipped with one or more wind speed sensors like, e.g., anemometers located on top of a nacelle measuring the wind speed and providing measured wind speed information (also referred to as “raw wind speed information”) as an output information.

However, due to disturbing effects caused by, e.g., a given structure of a rotor and the nacelle of the wind turbine the resulting wind field hitting the wind turbine is greatly disturbed. Consequently, a point measurement as typically captured by the nacelle anemometer does not provide the intended precise information about the free wind speed in front of the wind turbine.

To provide a suitable determination of the free wind speed based on anemometer measurements a modification or correction of the measured wind speed information at the output of the wind speed sensor is necessary.

To establish such kind of correction or translation of the measured wind speed information into free wind speed information a suitable determination of correction- or translation information (also referred to as “calibration information”) is necessary.

The calibration information may be represented by a transfer function reflecting a relationship between the output of the wind speed sensor at the nacelle and the true free wind speed in front of the wind turbine.

The determination of proper calibration information is difficult as the free wind speed is mainly not known. Without proper calibration, there might be an offset between raw wind speed information at the output of the wind sensor and the free wind speed in front of the rotor of up to 5 m/s.

According to an exemplary scenario two wind speed sensors like anemometers may be located on top of a nacelle. Thereby, one of the anemometers may serve as a primary sensor determining the wind speed in general. The other anemometer may serve as the secondary sensor as a backup in case of a fault situation of the primary sensor.

Several kinds of wind speed sensors are commonly known like, e.g., a mechanical cup anemometer or an ultrasonic anemometer. The ultrasonic anemometer measures the wind speed directly whereas the mechanical cup anemometer measures the rotational speed of the cups in Herz [HZ].

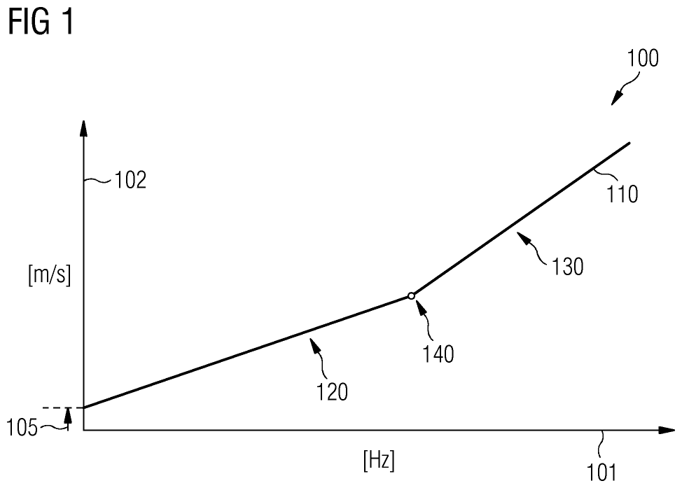

FIG. 1 exemplarily shows a graph 100 comprising a transfer function 110 representing calibration information being used to modify or translate captured raw wind speed information, i.e. rotational information (visualized via an abscissa 101 in [Hz]) provided by a mechanical cup anemometer into free wind speed information (visualized via an ordinate 102 in [m/s]). According to FIG. 1 the raw wind speed information is translated to the free wind speed information based on the transfer function 110 comprising an offset 105 as well as a first slope 120 and a second slope 130 being separated by a transition point 140.

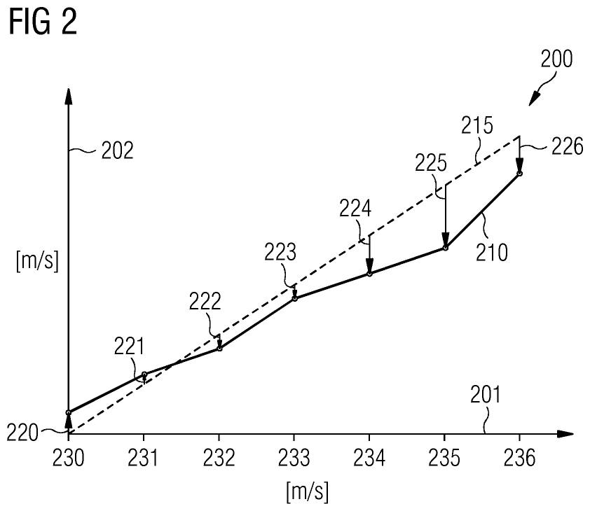

As a further example, FIG. 2 shows a graph 200 comprising a transfer function 210 representing calibration information being derived for an ultrasonic anemometer. Thereby an abscissa 201 is representing the ultrasonic anemometer output in [m/s] and an ordinate 202 is representing the free wind speed in [m/s].

As highlighted in FIG. 2 the transfer function 210 comprises a number of corrections (illustrated by respective arrows 200 to 226) in relation to a neutral transfer function (as indicated by a dotted line 215) wherein

a correction 220 is determined for a defined wind speed 230 (here 0 m/s),

a correction 221 is determined for a defined wind speed 231 (here 5 m/s),

a correction 222 is determined for a defined wind speed 232 (here 10 m/s),

a correction 223 is determined for a defined wind speed 233 (here 15 m/s),

a correction 224 is determined for a defined wind speed 234 (here 20 m/s),

a correction 225 is determined for a defined wind speed 235 (here 25 m/s),

a correction 226 is determined for a defined wind speed 236 (here 30 m/s),

The gradient or “design” of the transfer function 210 is the result of a calibration process.

According to possible known calibration techniques wind speed information provided by a metrology mast located in front of the rotor of a wind turbine may be used for calibration of a wind speed sensor.

Thereby, the wind speed information provided by the metrology mast is representing the free wind speed information being compared with the “raw” wind speed information provided by the wind speed sensor to be calibrated. However, such a metrology mast is available only in very rare situations for a given wind turbine, and especially wind turbines placed off-shore do most often not have such mast nearby. As a further disadvantage, such kind of calibration is only valid for an individual wind turbine and does not necessarily provided sufficient calibration results for other wind turbines even in case of the same type of wind turbines and wind sensors.

### SUMMARY

An aspect relates to an improved approach for determining suitable calibration information for a wind sensor of a wind turbine.

In order to overcome this problem, a method is provided for determining calibration information for at least one wind speed sensor of a wind turbine,
wherein measured wind speed information is provided by the at least one wind speed sensor,
wherein free wind speed information is estimated based on wind turbine individual operational information,
wherein the calibration information is determined based on
   the measured wind speed information and
   the estimated free wind speed information.

Measured or raw wind speed information may be provided by a wind speed sensor located on top of a nacelle of a wind turbine.

Free wind speed is the wind speed in front of a wind turbine, in particular in front of a rotor of the wind turbine.

According to one aspect of embodiments of the invention the free wind speed information may be estimated based on current individual operational data or information of a wind turbine. As an example, by determining a current power, a current rotor speed and a current blade pitch angle the current free wind speed information can be determined or estimated (“estimated free wind speed information”) based on a simulation of a wind turbine power production at given combinations of wind speed, rotor velocity and pitch angles. Such kind of method for estimating wind speed based on operational data is exemplarily disclosed in WO 2010/139372 A1.

Alternatively, the free wind speed information may be estimated by a self-tuning fixed order controller (also referred to as “LQG controller)” defined by a set of coefficients which are based on an empirical linear model of the system. This model is used to make predictions of the sensor measurements wherein prediction errors are used to update the coefficients of the model and the feedback law. The predicted sensor measurements may represent system state variables which may include, e.g., rotational speeds, torques, deflections as well as the actual free wind speed.

According to one further aspect of embodiments of the invention, the estimated free wind speed information may be compared or mapped with the measured wind speed information at the output of the wind speed sensor. As a result, proper calibration information can be derived, e.g. in form of a transfer function which may be the basis for a suitable translation of the measured wind speed information into the free wind speed information. The transfer function may be modeled on basis of linear or polynomial regression.

As an advantage, the derived calibration information is far more flexible in relation to the somewhat “simple” transfer functions 110, 210 as exemplarily shown in FIG. 1 and FIG. 2. In particular, a complex relationship between the wind speed sensor output and the free wind speed can be handled by the proposed calibration information. As a further advantage, no negative wind speeds will be provided by the inventive solution which is physically impossible.

Further, the proposed calibration information may be applied to even higher wind speeds being relevant for specific control features like “High Wind Ride Through”, i.e. a control scheme that allows for continued operation of a wind turbine above the normal cut-out wind speed normally set at e.g. 25 m/s.

In an embodiment, the calibration information comprises a transfer function representing a relationship between
the measured wind speed information and
the estimated free wind speed information.

In another embodiment, the relationship between the measured wind speed information and the estimated free wind speed information is modeled on basis of linear regression or polynomial regression.

In a further embodiment, the free wind speed information is estimated on basis of at least one current wind turbine individual operational information.

In a next embodiment, the free wind speed information is estimated based on
a measured current rotor speed of a rotor of the wind turbine,
a measured current power being generated by the wind turbine and
a measured current blade pitch angle of a rotor blade of the rotor.

It is also an embodiment that the free wind speed information is estimated based on
the at least one measured operational information and
a model of dynamics of the wind turbine.

Pursuant to another embodiment, the measured wind speed information or further measured wind speed information is processed on basis of the determined calibration information thereby translating the measured wind speed information into free wind speed information.

The problem stated above is also solved by a wind turbine comprising
at least one wind speed sensor providing measured wind speed information
a processing unit that is arranged for
   estimating free wind speed information based on wind turbine individual operational information and
   determining calibration information based on
      the measured wind speed information and
      the estimated free wind speed information.

The problem stated above is also solved by a device comprising and/or being associated with a processing unit and/or hard-wired circuit and/or a logic device that is arranged such that the method as described herein is executable thereon.

The processing unit may comprise at least one of the following: a processor, a microcontroller, a hard-wired circuit, an ASIC, an FPGA or a logic device.

The solution provided herein further comprises a computer program product (non-transitory computer readable storage medium having instructions, which when executed by a processor, perform actions) directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

### BRIEF DESCRIPTION

Some of the embodiments will be described in detail, with references to the following Figures, wherein like designations denote like members, wherein:

FIG. 1 exemplarily shows a graph comprising a transfer function representing known calibration information being used to modify or translate captured raw wind speed information provided by a mechanical cup anemometer into free wind speed information;

FIG. 2 shows a further example of a known transfer function representing calibration information defined for an ultrasonic anemometer; and

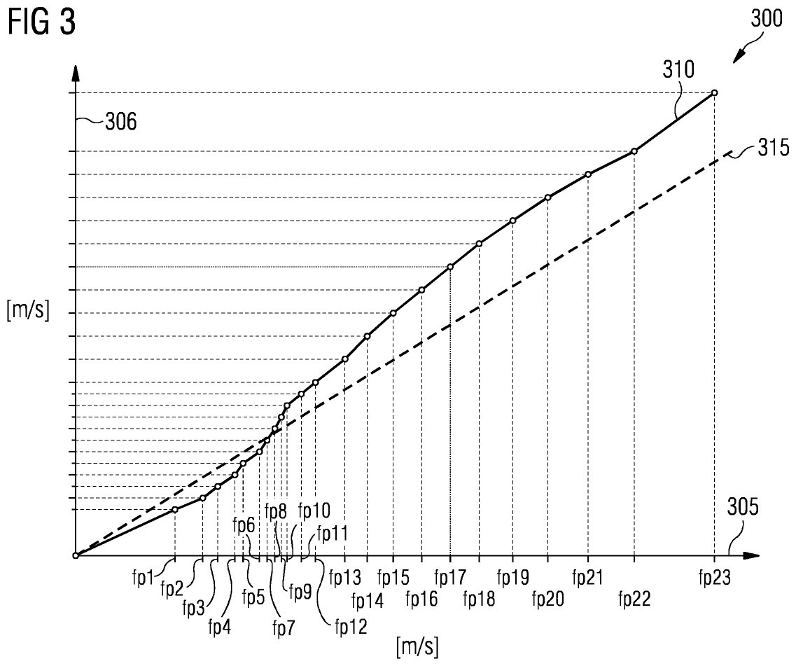

FIG. 3 shows an example of a complex transfer function as derived by the suggested solution.

### DETAILED DESCRIPTION

In respect of FIG. 3 the innovative determination of calibration information is now explained in more detail. The proposed determination of the calibration information can be implemented as an automated procedure executed, e.g., by an operational controller of the wind turbine or by any further specific controller being responsible for proper wind speed sensor calibration (“calibration procedure”).

### Initializing

In a first step, a default/initial transfer function may be selected as initial calibration based on a set of parameters being customized or individual to each wind turbine and/or wind sensor in order to account the differences across different wind turbine configurations. Possible embodiments of the default or initial transfer function may be a continuous line, or a known fixed calibration as exemplarily shown in FIG. 1 or FIG. 2. In FIG. 3 an exemplary initial transfer function 310 is visualized by a dotted line 315.

### Robust Calibration

According to the suggested solution the wind turbine controller continuously captures information (also referred to as “mapping information”), i.e.
measured wind speed information at the output of the wind speed sensor and
free wind speed information estimated on basis of operational information allowing to identify the “true” relationship between the measured wind speed information and the estimated free wind speed information.

As more and more mapping information is captured during the ongoing calibration procedure, the initial transfer function is modified or calibrated gradually to the resulting transfer function on basis of the captured mapping information.

As already mentioned, the resulting transfer function may be determined purely by mapping information provided by one individual wind turbine. After capturing or obtaining a sufficient amount of mapping information the ongoing calibration procedure may be stopped, i.e. the calibration is locked. That locking of the calibration (“calibration freeze”) allows a proper calibration process in due time and a correct determination of the free wind speed. A further advantage of the calibration freeze is the possible use of the captured mapping information for long time analysis of wind turbine performance degradation.

The calibration process may at any time be continued after a calibration freeze, either using existing data, e.g. data from a prior calibration process, or after a reset of the data e.g. after a pre-determined period of time and/or after servicing or parts exchange on the wind turbine.

According to one further aspect of the inventive calibration, the relation between the measured wind speed information and the estimated free wind speed information may be modeled on basis of linear or polynomial regression. In statistics, polynomial regression is a form of linear regression in which the relationship between an independent variable x (here the measured wind speed information) and the dependent variable y (here the free wind speed information) is modeled as an n'th degree polynomial in x. Polynomial regression fits a nonlinear relationship between the value of x and the corresponding conditional mean of y.

It should be noted that the relation between the measured wind speed information and the estimated free wind speed information may be determined based on an alternative statistical modeling.

The resulting transfer function may be represented by a straight line, a polynomial, or a piecewise function.

### Free Wind Speed Estimation

As already mentioned above, the estimated free wind speed information is part of the mapping information captured by the turbine controller during the calibration procedure. According to the proposed solution, the free wind speed information may be estimated or calculated on basis of current operating information or parameter like, e.g.
current pitch angle
current rotor speed
current power production
current air density
   which may be permanently measured by suitable sensors located in and/or at the wind turbine.

As already mentioned above a known solution for calculating or estimating the free wind speed can be found in WO2010/139372.

Alternatively, the free wind speed information may be estimated by a self-tuning fixed order controller (also referred to as “LQG controller)” defined by a set of coefficients which are based on an empirical linear model of the system. This model is used to make predictions of the sensor measurements wherein prediction errors are used to update the coefficients of the model and the feedback law. The predicted sensor measurements may represent system state variables which may include, e.g., rotational speeds, torques, deflections as well as the actual free wind speed. An example of a LQG controller based on a state estimator and optimal state feedback is disclosed in

### “The Design of Closed Loop Controllers for Wind Turbines”, E. A. Bossanyi, Wind Energy 2000; 3:149-163 “Advanced Controllers”.

FIG. 3 shows in a graph 300 an example of a resulting transfer function 310 after “calibration freeze”. Thereby, an abscissa 305 is representing measured wind speed information in [m/s] provided by a wind speed sensor on the nacelle. An ordinate 306 is representing estimated or free wind speed information in front of the rotor plane in [m/s].

A number of fixed points fp1 to fp23 are indicated at the abscissa 305 being identified during the calibration procedure and defining the final transfer function 310.

As an example, the second fixed point fp2 represents a measured wind speed of 6 m/s wherein the estimated free wind speed results in 5 m/s. As a consequence, the transfer function 310 is adapted/defined such that every time the wind speed sensor measures a wind speed of 6 m/s this measured wind speed information is corrected, i.e. translated according to the transfer function by a factor “−1” resulting in a free wind speed information of 5 m/s.

As a further example, the 17th fixed point fp17 represents a measured wind speed of 25.5 m/s wherein the estimated wind speed results in a value of 25 m/s during the calibration procedure the transfer function 310 has been adapted accordingly. Thus, after calibration freeze, every time the wind speed sensor measures a wind speed of 25.5 m/s this measurement result is corrected by “−0.5” resulting in a translated free wind speed information of 25 m/s.

This “piecewise” or “bin-related” definition of the transfer function 310 as visualized in FIG. 3 enables a more flexible transfer function allowing a high number of bins to separate the information captured during the calibration procedure. According to the example of FIG. 3 the transfer function is defined by 23 bins fp1 to fp23.

Different strategies may be applied to assign the captured mapping information to different bins. As an example, weight factors may be used depending on the distance between the respective measured wind speed and the different bins. Also partially overlapping bins or a combination/merge of several bins may be applied. Further, a differentiation between normal wind turbine operation and reduced wind turbine operation may be applied during the calibration procedure.

According to a further possible embodiment, status-information about the progress of the calibration procedure may be provided thereby allowing to determine or estimate the actual data quality of the adapted transfer function.

The main aspect of the inventive solution is the use of estimated free wind speed information obtained from current, i.e. measured, operational data of the wind turbine to calibrate wind speed sensors of a wind turbine. The proposed solution allows a precise determination of free wind speed being essential for an effective operation of the wind turbine.

Further, the proposed solution allows an automated determination of the calibration information. This is a significant advantage as the calibration procedure can be initialized or re-initialized at any time without the need for service personnel handling, e.g., wind turbine specific parameter setups.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for determining calibration information for at least one wind speed sensor of a wind turbine,
wherein measured wind speed information is provided by the at least one wind speed sensor,
wherein free wind speed information is estimated based on wind turbine individual operational information,
wherein the calibration information is determined based on:
the measured wind speed information, and
the estimated free wind speed information.

2. The method according to claim 2, wherein the calibration information comprises a transfer function representing a relationship between:
the measured wind speed information, and
the estimated free wind speed information.

3. The method according to claim 1, wherein the relationship between the measured wind speed information and the estimated free wind speed information is modeled on basis of linear regression or polynomial regression.

4. The method according to claim 1, wherein the free wind speed information is estimated on basis of at least one current wind turbine individual operational information.

5. The method according to claim 4, wherein
the free wind speed information estimated based on:
a measured current rotor speed of a rotor of the wind turbine,
a measured current power being generated by the wind turbine, and
a measured current blade pitch angle of a rotor blade of the rotor.

6. The method according to claim 4, wherein the free wind speed information is estimated based on:
the at least one measured operational information, and
a model of dynamics of the wind turbine.

7. The method according to claim 1, thereby processing the measured wind speed information or further measured wind speed information on basis of the determined calibration information thereby translating the measured wind speed information into free wind speed information.

8. A wind turbine, comprising:
at least one wind speed sensor providing measured wind speed information, and
a processing unit that is arranged for:
estimating free wind speed information based on wind turbine individual operational information, and
determining calibration information based on:
the measured wind speed information, and
the estimated free wind speed information.

9. A device comprising and/or being associated with a processor unit and/or hard-wired circuit and/or a logic device that is arranged such that the method according to claim 1 is executable thereon.

10. A computer program product, comprising a computer readable hardware storage device having computer readable program code stored therein, said program code executable by a processor of a comparer stem to implement a method directly loadable into a memory of a digital computer, comprising software code portions for performing the steps of the method according to claim 1.

11. A computer readable medium, having computer-executable instructions adapted to cause a computer system to perform the steps of the method according to claim 1.
